(19) United States
(12) Patent Application Publication
(10) Pub. No.: US 2025/0317831 A1
(43) Pub. Date: Oct. 9, 2025

(54) TRANSMITTING AND RECEIVING SYSTEM INFORMATION

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/088,811

(22) Filed: Mar. 24, 2025

Related U.S. Application Data
(60) Provisional application No. 63/631,686, filed on Apr. 9, 2024.
(60) Provisional application No. 63/692,509, filed on Sep. 9, 2024.
(60) Provisional application No. 63/705,381, filed on Oct. 9, 2024.

(51) Int. Cl. H04W 48/08

(52) U.S. Cl. CPC H04W 48/08

(57) ABSTRACT

A user equipment (UE) includes a transceiver configured to receive, from a wireless network, at least one message including configuration information for a system information block (SIB). The UE also includes a processor operably coupled to the transceiver. The processor is configured to obtain a reference configuration of the SIB, obtain a delta configuration of the SIB, and determine a full configuration of the SIB based on a combination of the reference configuration and the delta configuration. At least one of the reference configuration of the SIB and the delta configuration of the SIB are obtained based on the at least one message including the configuration information for the SIB.

### CROSS-REFERENCE TO RELATED APPLICATIONS AND CLAIM OF PRIORITY

This application claims priority under 35 U.S.C. § 119 (e) to U.S. Provisional Patent Application No. 63/631,686 filed on Apr. 9, 2024, U.S. Provisional Patent Application No. 63/692,509 filed on Sep. 9, 2024, and U.S. Provisional Patent Application No. 63/705,381 filed on Oct. 9, 2024. The above-identified provisional patent applications are hereby incorporated by reference in their entirety.

### TECHNICAL FIELD

This disclosure relates generally to wireless networks. More specifically, this disclosure relates to transmitting and receiving system information.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for transmitting and receiving system information.

In one embodiment, a user equipment (UE) is provided. The UE includes a transceiver configured to receive, from a wireless network, at least one message including configuration information for a system information block (SIB). The UE also includes a processor operably coupled to the transceiver. The processor is configured to obtain a reference configuration of the SIB, obtain a delta configuration of the SIB, and determine a full configuration of the SIB based on a combination of the reference configuration and the delta configuration. At least one of the reference configuration of the SIB and the delta configuration of the SIB are obtained based on the at least one message including the configuration information for the SIB.

In another embodiment, a base station (BS) is provided. The BS includes a processor, and a transceiver operatively coupled with the processor. The transceiver is configured to transmit, on a wireless network, at least one message including configuration information for a SIB. The configuration information includes at least one of a reference configuration of the SIB, and a delta configuration of the SIB.

In yet another embodiment, a method of operating a UE is provided. The method includes receiving, from a wireless network, at least one message including configuration information for a SIB, obtaining a reference configuration of the SIB, and obtaining a delta configuration of the SIB. The method also includes determining a full configuration of the SIB based on a combination of the reference configuration and the delta configuration. At least one of the reference configuration of the SIB and the delta configuration of the SIB are obtained based on the at least one message including the configuration information for the SIB.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure to acquire the configuration of a SIB in wireless communication network according to embodiments of the present disclosure;

FIG. 5 illustrates an example procedure to acquire the configuration of a SIB in wireless communication network according to embodiments of the present disclosure;

FIG. 6 illustrates another example procedure to acquire the configuration of a SIB in wireless communication network according to embodiments of the present disclosure;

FIG. 7 illustrates an example procedure for acquiring an SI message according to embodiments of the present disclosure;

FIG. 8 illustrates another example procedure for acquiring an SI message according to embodiments of the present disclosure;

FIG. 9 illustrates another example procedure for acquiring an SI message according to embodiments of the present disclosure;

FIG. 10 illustrates an example method for receiving system information according to embodiments of the present disclosure; and

FIG. 11 illustrates an example method for transmitting system information according to embodiments of the present disclosure.

### DETAILED DESCRIPTION

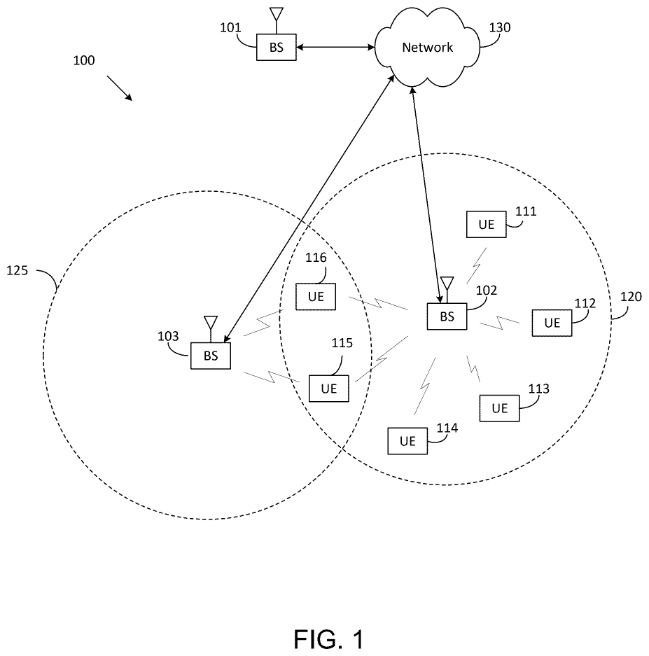

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for transmitting and receiving system information. In certain embodiments, one or more of the gNBs 101-103 includes circuitry, programing, or a combination thereof, to support transmitting and receiving system information in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

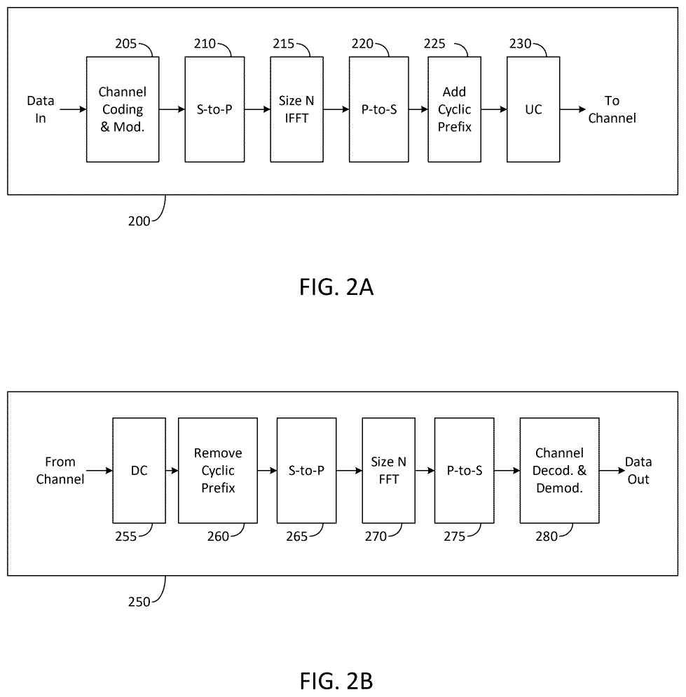

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support transmitting and receiving system information as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

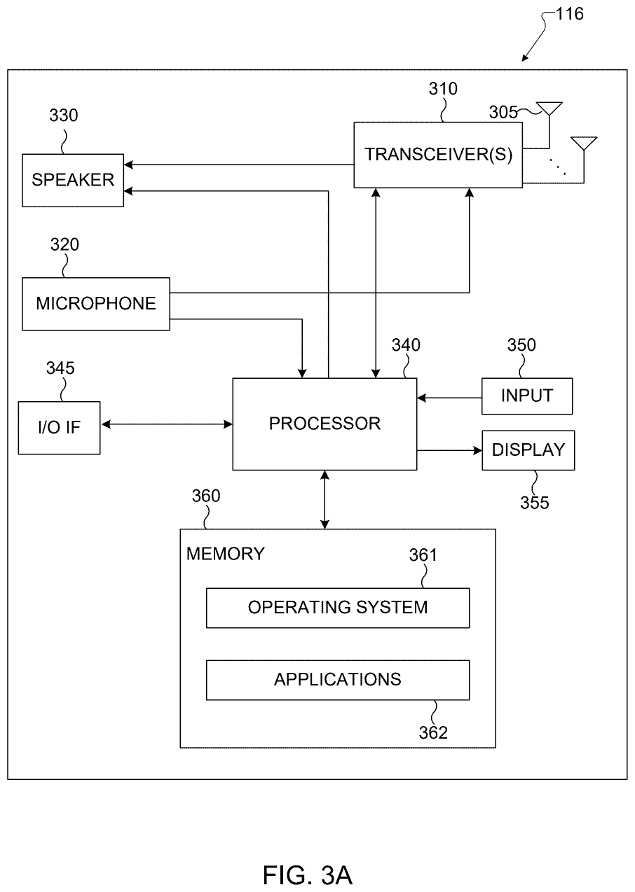

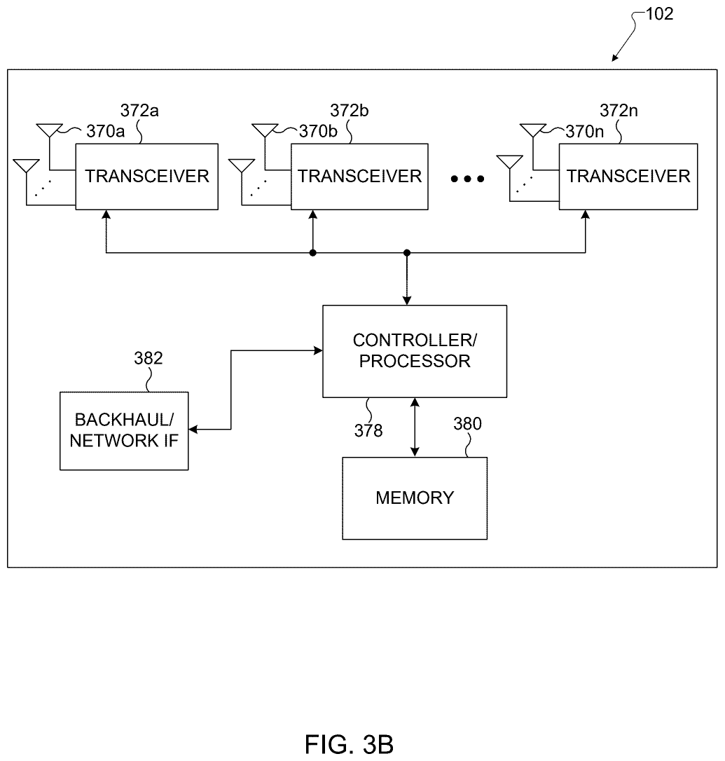

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for transmitting and receiving system information as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support transmitting and receiving system information as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs may communicate with each other using Beamforming. Beamforming techniques are used to mitigate propagation path losses and to increase propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can also be referred to as a transmit (TX) beam. Wireless communication systems operating at high frequency may use a plurality of narrow TX beams to transmit signals in the cell as each narrow TX beam provides coverage to a part of cell. The narrower the TX beam, the higher the antenna gain and hence a larger propagation distance of a signal transmitted using beamforming. A receiver can also generate plurality of receive (RX) beam patterns of different directions. Each of these receive patterns can be also referred to as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the Primary Cell (PCell) and optionally one or more secondary cells (SCells). In NR the term Secondary Cell Group (SCG) refers to a group of serving cells associated with the Secondary Node, comprising the Primary SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of a Special Cell. PSCell refers to a serving cell in the SCG in which the UE performs random access when performing the Reconfiguration with Sync procedure. For Dual Connectivity operation, Special Cell (SpCell) refers to the PCell of the MCG or the PSCell of the SCG. Otherwise, the term Special Cell refers to the PCell.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring a radio resource control (RRC) connected UE with BWP(s) and telling the UE which of the configured BWPs is currently the active one. When BA is configured, the UE only has to monitor PDCCH on the one active BWP i.e., it does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signalling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), a Physical Downlink Control Channel (PDCCH) is used to schedule DL transmissions on a Physical Downlink Shared Channel (PDSCH) and UL transmissions on a Physical Uplink Shared Channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for the Physical Uplink Control Channel (PUCCH) and PUSCH; transmission of one or more TPC commands for SRS transmissions by one or more UEs; switching a UE's active bandwidth part (BWP); and initiating a random access procedure. A UE monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCEs. Different code rates for the control channels are realized by aggregating different numbers of CCEs. Interleaved and non-interleaved CCE-to-REG mappings are supported in a CORESET. Polar coding is used for the PDCCH. Each resource element group carrying the PDCCH carries its own DeModulation Reference Signal (DMRS). Quadrature Phase Shift Keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0.$$

The starting symbol of a PDCCH monitoring occasion in each slot having PDCCH monitoring occasion is given by the parameter Monitoring-symbols-PDCCH-within-slot. The length (in symbols) of a PDCCH monitoring occasion is given in the CORESET associated with the search space. A search space configuration includes the identifier of CORESET configuration associated with it. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with an SSB/CSI RS of the TCI state) used by the gNB for transmission of the PDCCH in the PDCCH monitoring occasions of a search space.

In the next generation wireless communication system (e.g., 5G, beyond 5G, 6G), a node B (gNB) or base station in cell broadcast Synchronization Signal and PBCH (SS/PBCH) block (SSB), includes primary and secondary synchronization signals (PSS, SSS) and system information (SI). The SI includes common parameters needed to communicate in the cell. In the fifth generation wireless communication system (also referred as next generation radio or NR), SI is divided into the master information block (MIB) and a number of system information blocks (SIBs), wherein the MIB may be transmitted on the broadcast channel (BCH) with a periodicity of 80 ms and repetitions made within 80 ms and the MIB includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with a same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as an SI area, which includes one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In an RRC_CONNECTED state, the UE acquires the required SIB(s) from the PCell. For the PSCell and SCells, the network provides the required SI by dedicated signaling, i.e., within an RRCReconfiguration message. Nevertheless, the UE shall acquire a MIB of the PSCell to get system frame number (SFN) timing of the SCG (which may be different from the MCG). Upon change of relevant SI for the SCell, the network releases and adds the concerned SCell. For the PSCell, the required SI can be changed with Reconfiguration with Sync.

The UE acquires SIB 1 from the camped or serving cell. The UE checks the BroadcastStatus bit in SIB 1 for an SI message for the UE to acquire. The SI request configuration for the supplementary UL (SUL) is signaled by the gNB using the IE si-RequestConfigSUL in SIB1. If the IE si-RequestConfigSUL is not present in SIB1, the UE considers that the SI request configuration for the SUL is not signaled by the gNB. The SI request configuration for the normal UL (NUL) is signaled by the gNB using the IE si-RequestConfig in SIB1. If the IE si-RequestConfig is not present in the SIB1, the UE considers that the SI request configuration for the NUL is not signaled by the gNB. If an SI message which the UE should acquire is not being broadcast (i.e., BroadcastStatus bit is set to zero), the UE initiates transmission of an SI request. The procedure for SI request transmission is as follows:
If an SI request configuration is signaled by the gNB for a SUL, and criteria to select the SUL is met (i.e., RSRP derived from SSB measurements of the camped or serving cell<rsrp-ThresholdSSB-SUL, where rsrp-ThresholdSSB-SUL is signaled by the gNB [e.g., in broadcast signaling such as SIB1]), the UE initiates transmission of an SI request based on a Msg1 based SI request on the SUL. In other words, the UE initiates a random access procedure using the PRACH preamble(s) and PRACH resource(s) in the SI request configuration of the SUL. The UE transmits the Msg1 (i.e., random access preamble) and waits for acknowledgement for the SI request. Random access resources (PRACH preamble(s) and PRACH occasions [s]) indicated in the SI request configuration of the SUL are used for the Msg1. The Msg1 is transmitted on the SUL. If acknowledgement for the SI request is received, the UE monitors the SI window of the requested SI message in one or more SI period(s) of that SI message.
Otherwise, if an SI request configuration is signaled by the gNB for a NUL and criteria to select the NUL is met (i.e., the NUL is selected if the SUL is supported in the camped or serving cell and the RSRP derived from SSB measurements of the camped or serving cell>=rsrp-ThresholdSSB-SUL; Or the NUL is selected if an SUL is not supported in serving cell), the UE initiates transmission of an SI request based on a Msg1 based SI request on the NUL. In other words, the UE initiates a random Access procedure using the PRACH preamble(s) and PRACH resource(s) in the SI request configuration of the NUL. The UE transmits the Msg1 (i.e., random access preamble) and waits for acknowledgement for the SI request. Random access resources (PRACH preamble(s) and PRACH occasions [s]) indicated in the SI request configuration of the NUL are used for the Msg1. The Msg1 is transmitted on the NUL. If acknowledgement for the SI request is received, the UE monitors the SI window of the requested SI message in one or more SI period(s) of that SI message.
Otherwise, the UE initiates transmission of the SI request based on a Msg3 based SI request. In other words, the UE initiates transmission of an RRCSystemInfoRequest message. The UE transmits the Msg1 (i.e., random access preamble) and waits for a random access response. Common random access resources (PRACH preamble(s) and PRACH occasions(s)) are used for the Msg1. In the UL grant received in the random access response, the UE transmits an RRCSystemInfoRequest message and waits for acknowledgement for the SI request (i.e., RRCSystemInfoRequest message). If acknowledgement for the SI request (i.e., RRCSystemInfoRequest message) is received, the UE monitors the SI window of the requested SI message in one or more SI period(s) of that SI message. Note that if an SUL is configured, the UL carrier for Msg1 transmission will be selected by the UE in a similar manner as selected by the UE for the Msg1 based SI request. The SUL is the selected UL carrier if RSRP derived from SSB measurements of the camped or serving cell<rsrp-ThresholdSSB-SUL where rsrp-ThresholdSSB-SUL is signaled by the gNB (e.g., in broadcast signaling such as SIB1). The NUL is the selected UL carrier, if the RSRP derived from SSB measurements of the camped or serving cell>=rsrp-ThresholdSSB-SUL where rsrp-ThresholdSSB-SUL is signaled by the gNB (e.g., in broadcast signaling such as SIB1).

In the next generation wireless communication system (e.g., 5G, beyond 5G (B5G), 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in UL by non-synchronized UE in RRC CONNECTED state. Several types of random-access procedure are supported such as contention based random access, contention free random access and each of these can be one of 2 step or 4 step random access.

In contention based random access (CBRA), also referred as 4 step CBRA, the UE first transmits a random access preamble (also referred to as a Msg1) and then waits for a random access response (RAR) in the RAR window. The RAR is also referred to as a Msg2. A gNB transmits the RAR on the PDSCH. A PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission TX occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where the UE has transmitted the Msg1, (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for the NUL carrier and 1 for the SUL carrier). Several RARs for various Random-access preambles detected by the gNB can be multiplexed in the same RAR media access control (MAC) protocol data unit (PDU) by the gNB. The RAR in the MAC PDU corresponds to the UE's RA preamble transmission if the RAR includes an RA preamble identifier (RAPID) of the RA preamble transmitted by the UE. If the RAR corresponding to the UE's RA preamble transmission is not received during the RAR window and the UE has not yet transmitted the RA preamble for a configurable (configured by the gNB in a RACH configuration) number of times, the UE goes back to the first step (i.e., the UE selects a random access resource [preamble/RACH occasion]) and transmits the RA preamble. A backoff may be applied before going back to first step.

If the RAR corresponding to the UE's RA preamble transmission is received, the UE transmits a message 3 (Msg3) in the UL grant received in the RAR. The Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if the UE receives a PDCCH addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (the first X bits of a common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., the UE selects a random access resource [preamble/RACH occasion]) and transmits the RA preamble. A backoff may be applied before going back to first step.

Contention free random access (CFRA), also referred to 4 step CFRA, is used for scenarios such as handover where low latency is required, timing advance establishment for a secondary cell (Scell), etc. An eNB assigns to the UE a dedicated random access preamble. The UE transmits the dedicated RA preamble. The eNB transmits the RAR on a PDSCH addressed to a RA-RNTI. The RAR conveys an RA preamble identifier and timing alignment information. The RAR may also include an UL grant. The RAR is transmitted in a RAR window similar to CBRA procedure. The CFRA is considered successfully completed after receiving the RAR including RAPID of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

For certain events such has handover and beam failure recovery if dedicated preamble(s) are assigned to UE, during the first step of random access (i.e., during random access resource selection for Msg1 transmission) the UE determines whether to transmit a dedicated preamble or a non dedicated preamble. Dedicated preambles are typically provided for a subset of SSBs/CSI RSs. If there is no SSB/CSIRS with DL RSRP above a threshold amongst the SSBs/CSI RSs for which contention free random access resources (i.e., dedicated preambles/ROs) are provided by the gNB, the UE selects a non dedicated preamble. Otherwise the UE selects a dedicated preamble. During the RA procedure, one random access attempt can be a CFRA while other random access attempts can be CBRA.

In the first step of 2 step contention based random access (2 step CBRA), the UE transmits a random access preamble on a PRACH and a payload (i.e., MAC PDU) on a PUSCH. The random access preamble and payload transmission is also referred to as MsgA. In the second step, after MsgA transmission, the UE monitors for a response from the network (i.e., gNB) within a configured window. The response is also referred to as a MsgB. A gNB transmits the MsgB on the PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion [RO]) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for the NUL carrier and 1 for the SUL carrier).

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If a C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include fallback information corresponding to the random access preamble transmitted in the MsgA. If the fallback information is received, the UE transmits a Msg3 and performs contention resolution using a Msg4 as in CBRA procedure. If the contention resolution is successful, the random access procedure is considered successfully completed. If the contention resolution fails upon fallback (i.e., upon transmitting a Msg3), the UE retransmits the MsgA. If the configured window in which the UE monitors for a network response after transmitting the MsgA expires and the UE has not received a MsgB including contention resolution information or fallback information as explained above, the UE retransmits the MsgA. If the random access procedure is not successfully completed even after transmitting the MsgA a configurable number of times, The UE falls back to 4 step RACH procedure (i.e., the UE only transmits the PRACH preamble).

A MsgA payload may include one or more of a common control channel (CCCH) service data unit (SDU), dedicated control channel (DCCH) SDU, dedicated traffic channel (DTCH) SDU, buffer status report (BSR) MAC CE, power headroom report (PHR) MAC CE, SSB information, C-RNTI MAC CE, or padding. A MsgA may include a UE ID (e.g., random ID, S-TMSI, C-RNTI, resume ID, etc.) along with a preamble in the first step. The UE ID may be included in the MAC PDU of the MsgA. A UE ID such as C-RNTI may be carried in a MAC CE, wherein the MAC CE is included in the MAC PDU. Other UE IDs (such as a random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before it is attached to the network), then the UE ID is the random ID. When the UE performs RA in an IDLE state after the UE is attached to the network, the UE ID is the S-TMSI. If the UE has an assigned C-RNTI (e.g., in a connected state), the UE ID is the C-RNTI. In case the UE is in an INACTIVE state, the UE ID is the resume ID. In addition to the UE ID, some addition control information can be sent in a MsgA. The control information may be included in the MAC PDU of the MsgA. The control information may include one or more of a connection request indication, connection resume request indication, SI request indication, buffer status indication, beam information (e.g., one or more DL TX beam ID [s] or SSB ID [s]), beam failure recovery indication/information, data indicator, cell/BS/TRP switching indication, connection re-establishment indication, reconfiguration complete or handover complete message, etc.

For 2 step contention free random access (2 step CFRA) the gNB assigns to the UE a dedicated random access preamble(s) and PUSCH resource(s) for a MsgA transmission. RO(s) to be used for preamble transmission may also be indicated. In the first step, the UE transmits the random access preamble on a PRACH and a payload on a PUSCH using the contention free random access resources (i.e., a dedicated preamble/PUSCH resource/RO). In the second step, after MsgA transmission, the UE monitors for a response from the network (i.e., gNB) within a configured window. The response is also referred to as MsgB.

The gNB transmits the MsgB on a PDSCH. A PDCCH scheduling the PDSCH carrying the MsgB is addressed to a MSGB-RNTI. The MSGB-RNTI identifies the time-frequency resource (also referred to as a PRACH occasion or PRACH TX occasion or RO) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for the NUL carrier and 1 for the SUL carrier).

If the UE receives a PDCCH addressed to the C-RNTI, the random access procedure is considered successfully completed. If the UE receives fallback information corresponding to the UE's transmitted preamble, the random access procedure is considered successfully completed.

For certain events such has handover and beam failure recovery if dedicated preamble(s) and PUSCH resource(s) are assigned to the UE, during the first step of random access (i.e., during random access resource selection for MsgA transmission) the UE determines whether to transmit a dedicated preamble or non dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by the gNB, the UE selects a non dedicated preamble. Otherwise the UE selects a dedicated preamble. During the RA procedure, one random access attempt can be 2 step CFRA while other random access attempts can be 2 step CBRA.

Upon initiation of a random access procedure, The UE first selects the carrier (SUL or NUL). If the carrier to use for the random access procedure is explicitly signaled by the gNB, the UE selects the signaled carrier for performing the random access procedure. If the carrier to use for the random access procedure is not explicitly signaled by the gNB, and if the serving cell for the random access procedure is configured with a supplementary uplink, and if the RSRP of the downlink pathloss reference is less than rsrp-ThresholdSSB-SUL, the UE selects the SUL carrier for performing the random access procedure. Otherwise, the UE selects the NUL carrier for performing the random access procedure. Upon selecting the UL carrier, the UE determines the UL and DL BWP for the random access procedure. The UE then determines whether to perform 2 step or 4 step RACH for this random access procedure as follows:

If this random access procedure is initiated by a PDCCH order and if the ra-PreambleIndex explicitly provided by the PDCCH is not 0b000000, the UE selects 4 step RACH. Otherwise, if 2 step contention free random access resources are signaled by the gNB for this random access procedure, the UE selects 2 step RACH. Otherwise, if 4 step contention free random access resources are signaled by the gNB for this random access procedure, the UE selects 4 step RACH. Otherwise, if the UL BWP selected for this random access procedure is configured with only 2 step RACH resources, the UE selects 2 step RACH. Otherwise, if the UL BWP selected for this random access procedure is configured with only 4 step RACH resources, the UE selects 4 step RACH. Otherwise, if the UL BWP selected for this random access procedure is configured with both 2 step and 4 step RACH resources, if the RSRP of the downlink pathloss reference is below a configured threshold, the UE selects 4 step RACH. Otherwise, the UE selects 2 step RACH.

In existing wireless networks, system information is signaled in one or more SIBs. A SIB includes various configurations/parameters to be applied in the cell in which the SIB is transmitted. Several (or all) configuration/parameters and their values in the SIB can be the same across several cells. Even though several cells can support the same SIB, all the configurations/parameters of the SIB to be applied in each cell is broadcast by each cell. The current mechanism suffers from signaling overhead, increased UE and network energy consumption, etc.

Note that 5G systems support on demand system information which can reduce the signaling overhead of periodic broadcasts. However, even with this mechanism, upon request, a gNB broadcasts the full configuration/parameters of the requested SIB. Additionally, on demand SI requests do not work well in cells with higher UE arrival rates.

5G systems also support system information updates, wherein if any content in a SIB of a cell is changed, the cell notifies the UE by sending an SI update notification, and then the cell broadcasts the entire updated SIB. Even if a single parameter is changed, the UE acquires the entire SIB and the cell broadcasts the entire SIB.

Various embodiments of the present disclosure provide enhanced mechanisms for SI acquisition that partially or completely eliminate broadcasting of SIBs by replacing the broadcasts with on demand SI requests.

In existing procedures for 4 step RA based SI requests, a UE transmits a Msg1 (PRACH preamble/SI request) to a gNB and receives a RAR (SI request ack) from the gNB. A separate preamble/RO for each SI message not periodically broadcast is signaled by the gNB. In this procedure, there is no contention amongst a Msg1 for SI requests and Msg1s triggered by other random access events (such as connection setup, etc.). An issue with this approach is that a UE cannot request multiple SI message(s) at the time of sending an SI request. In order to support multiple SI message(s) at the time of sending an SI request (i.e., a Msg1/PRACH preamble), separate preambles/ROs need to be reserved for various combinations of SI messages. This is not possible due to limited RACH resources (such as preambles).

The existing procedures support another 4 step RA based SI request procedure wherein the UE transmits a Msg1 (PRACH preamble) to the gNB, the UE receives a RAR from the gNB including an UL grant, the UE transmits a Msg3 (SI request) in the UL grant to the gNB, and the UE receives a Msg4 (SI request ack) from the gNB. The SI request transmitted in the Msg3 is an RRC message and can indicate which SI message(s) the UE requests. An issue with this approach is that there is contention amongst Msg1s for SI requests and Msg1s triggered by other random access events (such as connection setup, etc.). Additionally, this procedure incurs more latency due to more message exchanges between the UE and the gNB.

Various embodiments of the present disclosure provide enhanced mechanisms for RA based SI requests that overcome the above issues.

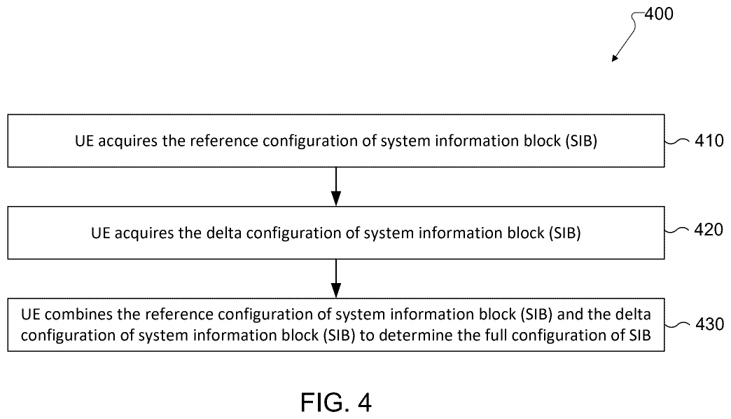

FIG. 4 illustrates an example procedure 400 to acquire the configuration of a SIB in wireless communication network according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure to acquire the configuration of a SIB in wireless communication network could be used without departing from the scope of this disclosure.

In the example of FIG. 4, procedure 400 beings at operation 410. At operation 410, a UE (such as UE 116 of FIG. 1) acquires the reference configuration of a SIB. In the present disclosure, a reference configuration of a SIB may refer to parameters of a SIB that are unchanged from a full configuration of a SIB. For example, the full configuration of the SIB may have been modified since the SIB was initially configured, and the reference configuration may include the parameters that were unmodified. If no parameters of the SIB have changed since the SIB was initially configured, the reference configuration may also be a full configuration of the SIB. For example, the initial configuration of the SIB may be a standardized configuration that has not been modified.

In some embodiments, there can be several system information blocks (SIBs), and the reference configuration can be a per SIB reference configuration (i.e., the reference configuration includes a reference configuration for each SIB). Alternatively, in some embodiments, there can be several system information blocks (SIBs), and each SIB can have a separate reference configuration.

In some embodiments, the reference configuration of a SIB can be preconfigured. For example, the reference information may be stored within a memory the UE. Alternatively, in some embodiments, a reference configuration of a SIB can be signaled to the UE by upper layer (e.g., non-access stratum [NAS]) signaling. Alternatively, in some embodiments, a reference configuration of a SIB can be pre-defined in a specification of the wireless communication system. Alternatively, in some embodiments, a SIB can be signaled to the UE (e.g., via a BS such as BS 102 of FIG. 1) when the UE registers with the network. Alternatively, in some embodiments, a reference configuration of a SIB can be signaled to the UE when the UE requests the reference configuration of the SIB in the cell (e.g., from a BS such as BS 102).

In some embodiments, a reference configuration of a SIB can be per public land mobile network (PLMN) (i.e., the UE applies the same reference configuration in all cells of a PLMN associated with that reference configuration). Alternatively, in some embodiments, a reference configuration of a SIB can be for a group of PLMNs (i.e., the UE applies the same reference configuration in all cells belonging to a group of PLMNs associated with that reference configuration). Alternatively, in some embodiments, a reference configuration of a SIB can be per tracking area/location update area (i.e., the UE applies the same reference configuration in all cells of a tracking area/location update area associated with that reference configuration). Alternatively, in some embodiments, a reference configuration of a SIB can be per SI area (i.e., the UE applies the same reference configuration in all cells belonging to the SI area associated with that reference configuration). Alternatively, in some embodiments, a reference configuration of a SIB can be per reference configuration area (i.e., the UE applies the same reference configuration in all cells belonging to the reference configuration area associated with that reference configuration). In some embodiments, the PLMNs/Tracking area/SI area/Reference configuration area associated with a reference configuration of a SIB can be signaled along with the reference configuration. Alternatively, in some embodiments, if the UE acquires a reference configuration of a SIB from a cell, the PLMNs/Tracking area/SI area/Reference configuration area associated with the cell can be the PLMNs/Tracking area/SI area/Reference configuration area associated with the reference configuration of the SIB.

In some embodiments, a reference configuration for a SIB can be stored for a pre-defined time (or configured time). In these embodiments, the UE may discard the acquired reference configuration after that time.

In some embodiments, the full configuration of a SIB used in a cell is equal to the delta configuration of the SIB+the reference configuration of the SIB. In the present disclosure, a delta configuration of a SIB may refer to parameters of a SIB that are unavailable and/or changed from the reference configuration of the SIB. For example, the full configuration of the SIB may have been modified since the SIB was initially configured, and the delta configuration may include the parameters that were modified. If no parameters of the SIB have changed since the SIB was initially configured, the delta configuration may be a null configuration that does not modify or add to the parameters of the reference configuration. For example, the full configuration of the SIB may be a standardized configuration that has not been modified.

In some embodiments, if the full configuration of a SIB in a cell is equal to the reference configuration+delta configuration and the UE does not have the reference configuration of the SIB, the UE may request the reference configuration of that SIB from the cell. The request sent to the cell may indicate whether the request is for the reference configuration and/or delta configuration or full configuration of the SIB. Requests for the reference configuration and/or delta configuration or full configuration for several SIB(s) can be sent together or separately. Based on the request, the network may provide the reference configuration and/or delta configuration. In some embodiments, a request sent to the cell may indicate whether the request is for the delta configuration or full configuration. In case the request is for the full configuration, the network provides the reference configuration and delta configuration. In case the request is for the delta configuration, the network provides the delta configuration. In some embodiments, the request sent to the cell may indicate whether the request is for the delta configuration or the reference configuration. In some embodiments, in case the request is for the reference configuration, the network provides the reference configuration and the delta configuration. In some embodiments, in case the request is for the delta configuration, the network provides the delta configuration. In some embodiments, in case the request is for the reference configuration, the network provides the reference configuration.

In some embodiments, there can be several reference configurations of a SIB. Each reference configuration of the SIB can be associated with a valueTag. In these embodiments, the valueTag of the reference configuration of the SIB used in a cell can be signaled by the cell. In some embodiments, if the valueTag is associated with the reference configuration of the SIB and the UE has the reference configuration corresponding to that valueTag, the UE applies the reference configuration corresponding to that valueTag. In some embodiments, if the UE does not have the reference configuration of the SIB which is used in the cell (i.e., the reference configuration of SIB corresponding to the valueTag), the UE may request the reference configuration of that SIB from the cell. In some embodiments, the UE may include the valueTag in the request of the reference configuration.

In some embodiments, if a valueTag and an area (the area can be PLMN(s)/Tracking area/SI area/Reference configuration area, etc.) is associated with a reference configuration of the SIB, the UE applies the reference configuration corresponding to that valueTag and area. In some embodiments, if the UE does not have the reference configuration of the SIB which is used in cell (i.e., the reference configuration of the SIB corresponding to the valueTag and area), the UE may request the reference configuration of that SIB from the cell.

At operation 420, the UE acquires the delta configuration of the SIB.

In some embodiments, the delta configuration of the SIB is periodically broadcast or provided on demand in the cell. In some embodiments, if the UE does not have the delta configuration and the delta configuration is not periodically broadcast (or provided on demand), they UE may request the delta configuration from the cell. The request sent to the cell may indicate whether the request is for the reference configuration and/or delta configuration or the full configuration. Based on the request, the network may provide the reference configuration and/or delta configuration. In some embodiments, the request sent to the cell may indicate whether the request is for the delta configuration or the full configuration. In case the request is for the full configuration, the network provides the reference configuration and the delta configuration. In case the request is for the delta configuration, the network provides the delta configuration. In some embodiments, the request sent to the cell may indicate whether the request is for the delta configuration or the reference configuration. In case the request is for the reference configuration, the network provides the reference configuration and the delta configuration. In case the request is for the delta configuration, the network provides the delta configuration.

At operation 430, the UE combines the reference configuration of the SIB and the delta configuration of the SIB to determine the full configuration of the SIB.

Although FIG. 4 illustrates one example procedure 400 to acquire the configuration of a SIB in wireless communication network, various changes may be made to FIG. 4. For example, while shown as a series of operations, various operations in FIG. 4 could overlap, occur in parallel, occur in a different order, occur any number of times, be omitted, or replaced by other operations.

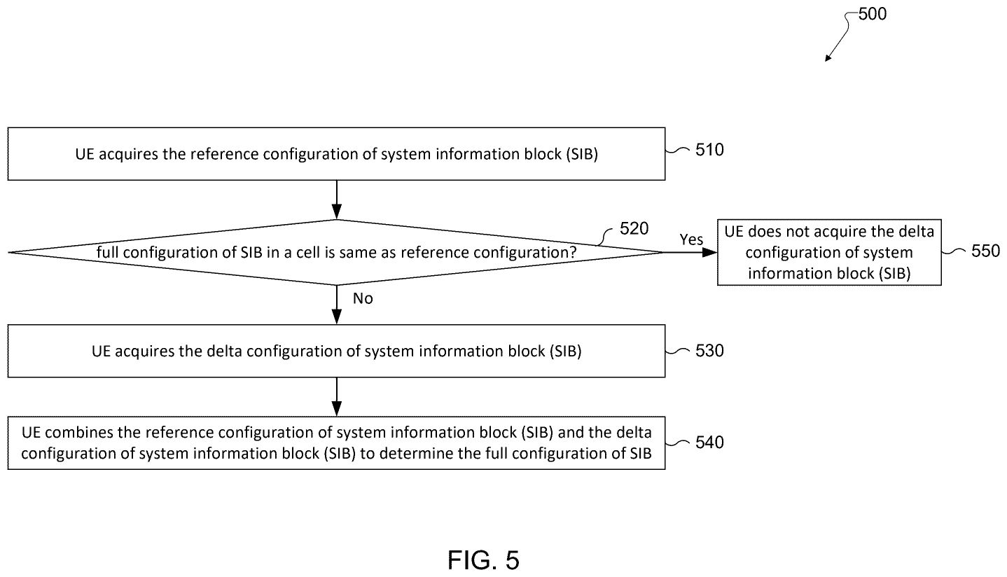

FIG. 5 illustrates an example procedure 500 to acquire the configuration of a SIB in wireless communication network according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure to acquire the configuration of a SIB in wireless communication network could be used without departing from the scope of this disclosure.

In the example of FIG. 5, procedure 500 beings at operation 510. At operation 510, a UE (such as UE 116 of FIG. 1) acquires the reference configuration of a SIB. The reference configuration may be similar as described regarding procedure 400 of FIG. 4.

In some embodiments, there can be several system information blocks (SIBs), and the reference configuration can be a per SIB reference configuration (i.e., the reference configuration includes a reference configuration for each SIB). Alternatively, in some embodiments, there can be several system information blocks (SIBs), and each SIB can have a separate reference configuration.

In some embodiments, the reference configuration of a SIB can be preconfigured. For example, the reference information may be stored within a memory the UE. Alternatively, in some embodiments, a reference configuration of a SIB can be signaled to the UE by upper layer (e.g., non-access stratum [NAS]) signaling. Alternatively, in some embodiments, a reference configuration of a SIB can be pre-defined in a specification of the wireless communication system. Alternatively, in some embodiments, a SIB can be signaled to the UE (e.g., via a BS such as BS 102 of FIG. 1) when the UE registers with the network. Alternatively, in some embodiments, a reference configuration of a SIB can be signaled to the UE when the UE requests the reference configuration of the SIB in the cell (e.g., from a BS such as BS 102).

In some embodiments, a reference configuration of a SIB can be per public land mobile network (PLMN) (i.e., the UE applies the same reference configuration in all cells of a PLMN associated with that reference configuration). Alternatively, in some embodiments, a reference configuration of a SIB can be for a group of PLMNs (i.e., the UE applies the same reference configuration in all cells belonging to a group of PLMNs associated with that reference configuration). Alternatively, in some embodiments, a reference configuration of a SIB can be per tracking area/location update area (i.e., the UE applies the same reference configuration in all cells of a tracking area/location update area associated with that reference configuration). Alternatively, in some embodiments, a reference configuration of a SIB can be per SI area (i.e., the UE applies the same reference configuration in all cells belonging to the SI area associated with that reference configuration). Alternatively, in some embodiments, a reference configuration of a SIB can be per reference configuration area (i.e., the UE applies the same reference configuration in all cells belonging to the reference configuration area associated with that reference configuration). The PLMNs/Tracking area/SI area/Reference configuration area associated with a reference configuration of a SIB can be signaled along with the reference configuration. Alternatively, if the UE acquires a reference configuration of a SIB from a cell, the PLMNs/Tracking area/SI area/Reference configuration area associated with the cell can be the PLMNs/Tracking area/SI area/Reference configuration area associated with the reference configuration of the SIB.

In some embodiments, there can be several reference configurations of a SIB. Each reference configuration of the SIB can be associated with a valueTag. In these embodiments, the valueTag of the reference configuration of the SIB used in a cell can be signaled by the cell. In some embodiments, if the valueTag is associated with the reference configuration of the SIB (i.e., the UE has the reference configuration), the UE applies the reference configuration corresponding to that valueTag. In some embodiments, If the UE does not have reference configuration of the SIB which is used in the cell (i.e., the reference configuration of SIB corresponding to valueTag), the UE may request the reference configuration of that SIB from the cell.

In some embodiments, if a valueTag and an area (the area can be PLMN(s)/Tracking area/SI area/Reference configuration area, etc.) is associated with a reference configuration of the SIB, the UE applies the reference configuration corresponding to that valueTag and area. In some embodiments, if the UE does not have the reference configuration of the SIB which is used in cell (i.e., the reference configuration of the SIB corresponding to the value Tag and area), the UE may request the reference configuration of that SIB from the cell.

In some embodiments, the full configuration of a SIB used in a cell is equal to the delta configuration of the SIB+the reference configuration of the SIB. The delta configuration may be similar as described regarding procedure 400 of FIG. 4. In some embodiments, if the full configuration of a SIB in a cell is equal to the reference configuration+delta configuration and the UE does not have the reference configuration of the SIB, the UE may request the reference configuration of that SIB from the cell. The request sent to the cell may indicate whether the request is for the reference configuration and/or delta configuration or full configuration of the SIB. Based on the request, the network may provide the reference configuration and/or delta configuration. In some embodiments, a request sent to the cell may indicate whether the request is for the delta configuration or full configuration. In case the request is for the full configuration, the network provides the reference configuration and delta configuration. In case the request is for the delta configuration, the network provides the delta configuration. In some embodiments, the request sent to the cell may indicate whether the request is for the delta configuration or the reference configuration. In some embodiments, in case the request is for the reference configuration, the network provides the reference configuration and the delta configuration. In some embodiments, in case the request is for the delta configuration, the network provides the delta configuration. In some embodiments, in case the request is for the reference configuration, the network provides the reference configuration.

At operation 520, the UE determines whether the full configuration of the SIB is the same as the reference configuration. If the full configuration of the SIB in the cell is the same as the reference configuration, the cell may not signal the delta configuration of SIB, and the UE does not acquire the delta configuration (operation 550). In some embodiments, the cell may broadcast a configuration identity of the SIB. The configuration identity can be set to a default identity (e.g., zero) to indicate that the full configuration of the SIB in the cell is the same as the reference configuration. The configuration identity can be set to a non default identity to indicate that the full configuration of the SIB in the cell is equal to the reference configuration+delta configuration.

At operation 520, if the full the configuration of the SIB in the cell is equal to the reference configuration+delta configuration, the procedure proceeds to operation 530.

At operation 530, the UE acquires the delta configuration of the SIB. If the UE does not have the delta configuration and the delta configuration is not periodically broadcast (or provided on demand), the UE may request the delta configuration from the cell. The request sent to the cell may indicate whether the request is for the reference configuration and/or delta configuration or the full configuration. Based on the request, the network may provide the reference configuration and/or delta configuration. In some embodiments, the request sent to the cell may indicate whether the request is for the delta configuration or full configuration. In case the request is for the full configuration, the network provides the reference configuration and the delta configuration. In case the request is for the delta configuration, the network provides the delta configuration. In some embodiments, the request sent to the cell may indicate whether the request is for the delta configuration or the reference configuration. In case request is for the reference configuration, the network provides the reference configuration and delta configuration. In case request is for the delta configuration, the network provides the delta configuration.

At operation 540, the UE combines the reference configuration of the SIB and the delta configuration of the SIB to determine the full configuration of the SIB.

Although FIG. 5 illustrates one example procedure 500 to acquire the configuration of a SIB in wireless communication network, various changes may be made to FIG. 5. For example, while shown as a series of operations, various operations in FIG. 5 could overlap, occur in parallel, occur in a different order, occur any number of times, be omitted, or replaced by other operations.

In some embodiments, if a parameter/field is not present in a reference configuration of a SIB but present in the delta configuration of the SIB, the parameter/field may be considered to be present in the full configuration of the SIB. In some embodiments, if a parameter/field is present in a reference configuration of a SIB and also present in the delta configuration of the SIB with a different value, the value of the parameter/field in the delta configuration may be considered to be present in the full configuration of SIB. In some embodiments, if a parameter/field is present in a reference configuration of a SIB but not present in the delta configuration of the SIB, the parameter/field may be considered to be present in the full configuration of SIB. In some embodiments, if a parameter/field is present in a reference configuration of a SIB with need code ‘M’ but not present in the delta configuration of the SIB, the parameter/field may be considered to be present in the full configuration of SIB. In some embodiments, if a parameter/field is present in a reference configuration of a SIB without need code ‘M’ but not present in the delta configuration of the SIB, the parameter/field may be considered to be not present in the full configuration of SIB.

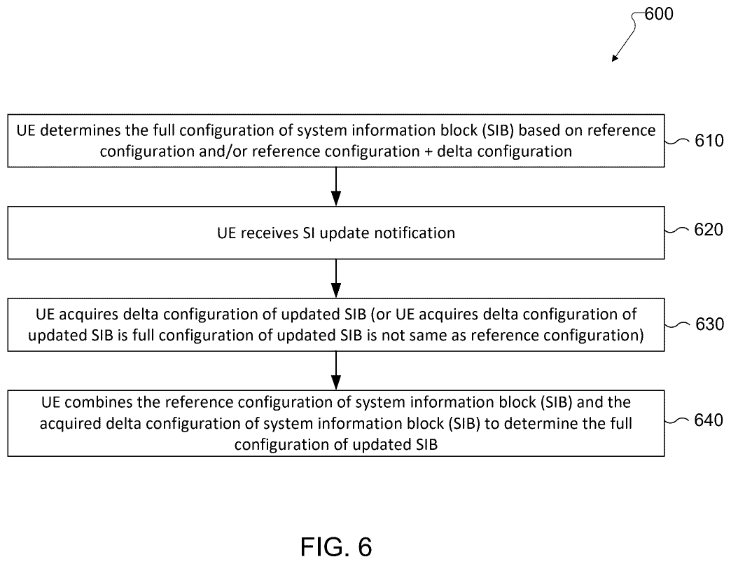

FIG. 6 illustrates another example procedure 600 to acquire the configuration of a SIB in wireless communication network according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure to acquire the configuration of a SIB in wireless communication network could be used without departing from the scope of this disclosure.

In the example of FIG. 6, procedure 600 beings at operation 610. At operation 610, a UE (such as UE 116 of FIG. 1) acquires the full configuration of a SIB based on a reference configuration and/or reference configuration+delta configuration of the SIB. For example, the full configuration may be acquired according to one of procedure 400 of FIG. 4 or procedure 500 of FIG. 5.

At operation 620, the configuration of the SIB is updated by the cell, and the cell transmits (for example, in a broadcast message) a SI update notification which is received by the UE.

At operation 630, for the updated SIB, the UE acquires the delta configuration of the updated SIB (or the UE acquires the delta configuration of the updated SIB if the full configuration of the updated SIB is not the same as the reference configuration).

At operation 640, the UE determines the full configuration of the updated SIB based on the reference configuration and/or reference configuration+delta configuration of the updated SIB.

Although FIG. 6 illustrates one example procedure 600 to acquire the configuration of a SIB in wireless communication network, various changes may be made to FIG. 6. For example, while shown as a series of operations, various operations in FIG. 6 could overlap, occur in parallel, occur in a different order, occur any number of times, be omitted, or replaced by other operations.

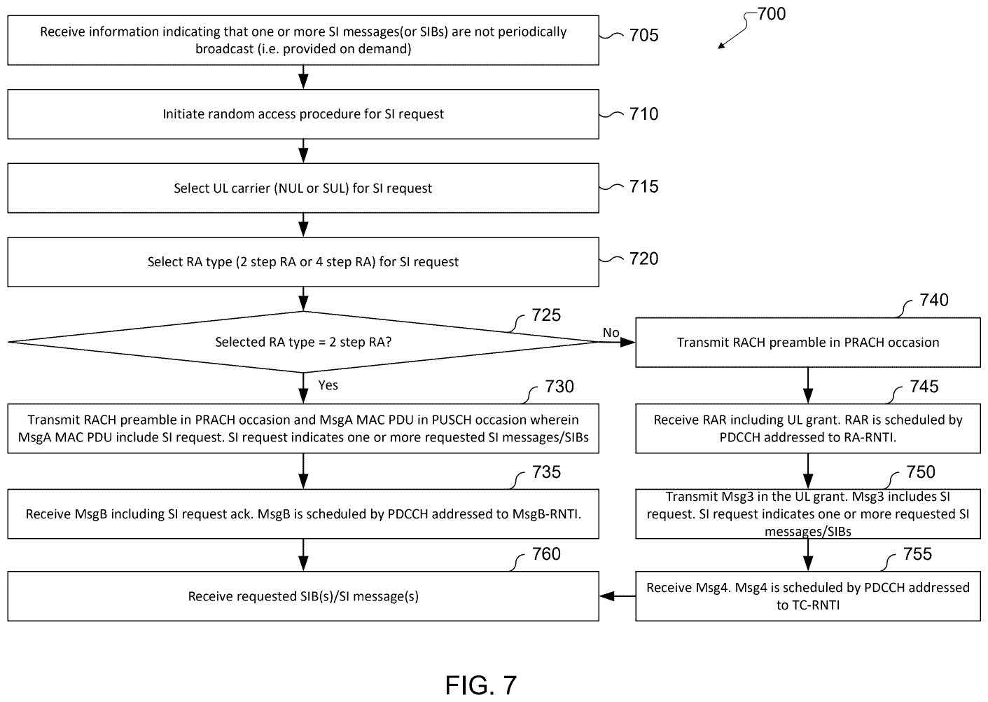

FIG. 7 illustrates an example procedure 700 for acquiring an SI message according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 7, procedure 700 beings at operation 705. At operation 705, a UE (such as UE 116 of FIG. 1) receives information indicating that one or more SI messages (or SIBs) of the currently camped cell are not periodically broadcast (e.g., information indicating that the SI messages are provided on demand). The indication that an SI message (or SIB) is not periodically broadcast (e.g., the information indicating the SI message is provided on demand) can be per SI message (or SIB) or can be common for all SI messages (SIBs) supported in the cell. The information can be received in a RRC message or system information. The information can be received from a gNB of the currently camped cell or from a neighboring cell.

At operation 710, if the UE is missing SI for operating in the currently camped cell and the SI is not broadcast in one or more SI messages (SIBs) (i.e., the SI message [or SIB] is provided on demand), the UE initiates a random access procedure to request one or more SI messages (SIBs).

At operation 715, the UE selects an UL carrier (NUL or SUL) of the cell for the SI request. If a SUL is supported in the cell and the RSRP (the RSRP may be derived from SSB/DL RS measurements of SSBs/DL RSs transmitted by the cell)>=rsrp-ThresholdSSB-SUL, the UE selects the NUL. If a SUL is supported in the camped cell and the RSRP (the RSRP may be derived from SSB/DL RS measurements of the camped cell)<rsrp-ThresholdSSB-SUL, the UE selects the SUL. If a SUL is not supported in the camped cell, the UE selects the NUL. In some embodiments, if there is only one UL carrier in a cell, the UE may not perform selection between the SUL and NUL and the UE uses the UL carrier of the cell for the SI request.

At operation 720, the UE selects an RA type (2 step RA or 4 step RA) for the SI request. Note that under existing procedures, the UE always selects 4 step RA for an SI request. If random access resources/configuration for only 4 step RA is configured in the selected UL carrier of the cell (or in the BWP of the selected UL carrier of the cell), the UE selects 4 step RA. If random access resources/configuration for only 2 step RA is configured in the selected UL carrier of the cell (or in the BWP of the selected UL carrier of the cell), the UE selects 2 step RA. If random access resources/configurations for both 2 step RA and 4 step RA are configured in the selected UL carrier of the cell (or in the BWP of the selected UL carrier of the cell): if RSRP of the downlink pathloss reference is below a configured threshold, the UE selects 4 step RA; Otherwise the UE selects 2 step RA.

The BWP of the cell can be the initial uplink BWP of the selected UL carrier. If the UE is neither a redcap UE nor an eRedcap UE, the BWP of the cell can be the initial uplink BWP of the selected UL carrier. If the UE is an (e) redcap UE, the BWP of the cell can be a redcap specific initial uplink BWP of the selected UL carrier. If the UE is an (e) redcap UE, the BWP of the cell can be the initial uplink BWP (if a redcap specific initial uplink BWP is not configured) of the selected UL carrier. The random access resources/configuration for 4 step RA can be the random access resources/configuration for 4 step RA not associated with any feature (note that there can be several random access resources/configurations where each can be associated with a feature/feature combination. The feature can be small data transmission (SDT), redcap, Msg3 repetition, Msg1 repetitions etc.).

The random access resources/configuration for 4 step RA can be the random access resources/configuration for 4 step RA associated with the SI request. The random access resources/configuration for 4 step RA can be the random access resources/configuration for 4 step RA associated with Msg3 repetition, if criteria to apply Msg3 repetition is met for the random access procedure initiated for the SI request. The random access resources/configuration for 4 step RA can be the random access resources/configuration for 4 step RA associated with a specific Msg1 repetition number, if criteria to apply that Msg1 repetition number is met for the random access procedure initiated for the SI request.

The random access resources/configuration for 2 step RA can be the random access resources/configuration for 2 step RA associated with the SI request. The random access resources/configuration for 2 step RA can be the random access resources/configuration for 2 step RA associated with Msg3 repetition, if criteria to apply Msg3 repetition is met for the random access procedure initiated for the SI request. The random access resources/configuration for 2 step RA can be the random access resources/configuration for 2 step RA associated with a specific Msg1 repetition number, if criteria to apply that Msg1 repetition number is met for the random access procedure initiated for the SI request.

At operation 725, if the selected RA type is 2 step RA, procedure 700 proceeds to operation 730. Otherwise, the procedure 700 proceeds to operation 750.

At operation 730, first the UE selects (e.g., randomly) a random access preamble from random access preambles for 2 step RA configured by the random access resources/configuration of the 2 step RA. The random access preamble may be selected from preambles of a specific group (e.g., group A or group B, where the random access resources/configuration may configure only group A or both group A and group B). The random access preamble may be selected corresponding to an SSB/CSI RS from preambles of the specific group. The UE may select an SSB/CSI RS based on an SS-RSRP/CSI-RSRP of SSBs/CSI RSs transmitted by the cell.

Second, at operation 730, the UE selects (e.g., randomly) a random access occasion (or PRACH occasion) from random access occasions (PRACH occasions) of the 2 step RA configured by the random access resources/configuration of the 2 step RA. The random access occasion (or PRACH occasion) may be selected corresponding to an SSB/CSI RS. The UE may select an SSB/CSI RS based on an SS-RSRP/CSI-RSRP of SSBs/CSI RSs transmitted by the cell.

Third, at operation 730, the UE selects (e.g., randomly or first available) a PUSCH occasion from PUSCH occasions for 2 step RA configured the by random access resources/configuration of the 2 step RA. The UE may select a PUSCH occasion corresponding to the selected preamble and PRACH occasion from PUSCH occasions of 2 step RA configured by the random access resources/configuration of 2 step RA.

Finally, at operation 730, the UE transmits (on the selected UL carrier) the selected RACH preamble in the selected PRACH occasion and a MsgA MAC PDU in the selected PUSCH occasion, wherein the MsgA MAC PDU includes the SI request. The SI request indicates or includes information indicating one or more requested SI messages/SIBs. In some embodiments, the SIB can be any SIB other than SIB1. In some embodiments, the SIB can be any SIB including SIB1.

At operation 735, the UE receives a MsgB including the SI request ack after transmitting the selected RACH preamble in the selected PRACH occasion and a MsgA MAC PDU in the selected PUSCH occasion. The MsgB is scheduled by a PDCCH addressed to a MsgB-RNTI. The UE monitors the PDCCH addressed to the MsgB-RNTI in a MsgB window after transmitting the selected RACH preamble in the selected PRACH occasion and a MsgA MAC PDU in the selected PUSCH occasion. After receiving the MsgB including the SI request ack, the UE receives the requested SIB(s)/SI message(s) at operation 760. If the UE receives a MsgB including UL grant and not the SI request ack after transmitting the selected RACH preamble in the selected PRACH occasion and a MsgA MAC PDU in the selected PUSCH occasion, the UE transmits Msg3 (i.e., a MsgA MAC PDU is transmitted as a Msg3 MAC PDU) in the UL grant. The UE receives a Msg4 including an SI request ack after transmitting the Msg3. The Msg4 is scheduled by a PDCCH addressed to a TC-RNTI. The UE monitors for a PDCCH addressed to the TC-RNTI after transmitting Msg3. After receiving the Msg4 including the SI request ack, the UE receives the requested SIB(s)/SI message(s) at operation 760.

At operation 740, first the UE randomly selects a random access preamble from random access preambles of the 4 step RA configured by the random access resources/configuration of the 4 step RA. The random access preamble may be selected from preambles of a specific group (e.g., group A or group B, where the random access resources/configuration may configure only group A or both group A and group B). The random access preamble may be selected corresponding to an SSB/CSI RS from preambles of a specific group. The UE may select an SSB/CSI RS based on an SS-RSRP/CSI-RSRP of SSBs/CSI RSs transmitted by the cell.

Second, at operation 740, the UE randomly selects a random access occasion (or PRACH occasion) from random access occasions (PRACH occasions) of the 4 step RA configured by the random access resources/configuration of the 4 step RA. The random access occasion (or PRACH occasion) may be selected corresponding to an SSB/CSI RS. The UE may select an SSB/CSI RS based on an SS-RSRP/CSI-RSRP of SSBs/CSI RSs transmitted by the cell.

Finally, at operation 740, the UE transmits the selected RACH preamble in the selected PRACH occasion.

At operation 745, the UE receives a RAR including an UL grant after transmitting the selected RACH preamble in the selected PRACH occasion. The RAR is scheduled by a PDCCH addressed to an RA-RNTI. The UE monitors the PDCCH addressed to the RA-RNTI in a RAR window after transmitting the selected RACH preamble in the selected PRACH occasion.

At operation 750, after receiving the RAR including the UL grant, the UE transmits a Msg3 in the UL grant, wherein the Msg3 MAC PDU includes the SI request. The SI request indicates or includes information indicating one or more requested SI messages/SIBs. In some embodiments, the SIB can be any SIB other than SIB1. In some embodiments, the SIB can be any SIB including SIB1.

At operation 755, the UE receives a Msg4 including an SI request ack after transmitting the Msg3. The Msg4 is scheduled by a PDCCH addressed to a TC-RNTI. The UE monitors for the PDCCH addressed to the TC-RNTI after transmitting the Msg3. After receiving the Msg4including the SI request ack, the UE receives the requested SIB(s)/SI message(s) at operation 760.

Although FIG. 7 illustrates one example procedure 700 for acquiring an SI message, various changes may be made to FIG. 7. For example, while shown as a series of operations, various operations in FIG. 7 could overlap, occur in parallel, occur in a different order, occur any number of times, be omitted, or replaced by other operations.

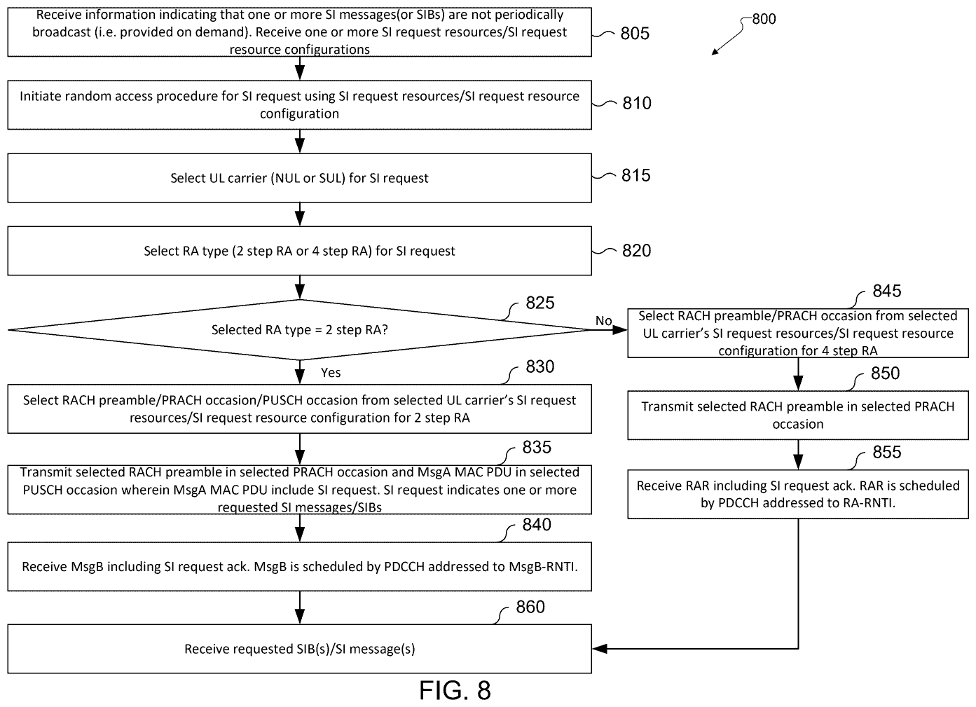

FIG. 8 illustrates another example procedure 800 for acquiring an SI message according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 8, procedure 800 beings at operation 805. At operation 805, a UE (such as UE 116 of FIG. 1) receives information indicating that one or more SI messages (or SIBs) of the currently camped cell are not periodically broadcast (e.g., information indicating that the SI messages are provided on demand). The indication that an SI message (or SIB) is not periodically broadcast (e.g., the information indicating the SI message is provided on demand) can be per SI message (or SIB) or can be common for all SI messages (SIBs) supported in the cell. The UE also receives one or more SI request resources/SI request resource configurations. In some embodiments, the SI request resources/SI request resource configurations can be received for 4 step RA and/or 2 step RA. In some embodiments, the SI request resources/SI request resource configurations can be received for 4 step RA and/or 2 step RA separately for a SUL and an NUL. In some embodiments, each SI request resources/SI request resource configuration can be for a specific RA type and a specific UL carrier and a specific repetition number. The information can be received in a RRC message or system information. The information can be received from a gNB of the currently camped cell or from a neighboring cell.

In some embodiments, the SI request resources/SI request resource configuration for 2step RA may indicate one or more preambles indexes, an RO mask index, one or more PUSCH resource index(s), and a PUSCH resource configuration. This information is common for an SI request for any SIB/SI message. In some embodiments, this information can be signaled separately for different group of SIBs/SI messages.

In some embodiments, ra-PreambleStartIndex can be signaled in the SI request resources/SI request resource configuration for 2 step RA. If N SSBs are associated with a RACH occasion, where N>=1, for the i-th SSB (i=0, . . . , N−1) the preamble with preamble index=ra-PreambleStartIndex+i is used for the SI request. For N<1, the preamble with preamble index=ra-PreambleStartIndex is used for the SI request.

At operation 810, if the UE is missing SI for operating in the currently camped cell and the SI is not broadcast in one or more SI messages (SIBs) (i.e., the SI message [or SIB] is provided on demand), the UE initiates a random access procedure to request one or more SI messages (SIBs).

At operation 815, the UE selects an UL carrier (NUL or SUL) of the cell for the SI request. If a SUL is supported in the cell and the RSRP (the RSRP may be derived from SSB/DL RS measurements of SSBs/DL RSs transmitted by the cell)>=rsrp-ThresholdSSB-SUL, the UE selects the NUL. If a SUL is supported in the camped cell and the RSRP (the RSRP may be derived from SSB/DL RS measurements of the camped cell)<rsrp-ThresholdSSB-SUL, the UE selects the SUL. If a SUL is not supported in the camped cell, the UE selects the NUL.

At operation 820, the UE selects an RA type (2 step RA or 4 step RA) for the SI request. If SI request resources/configuration for 2 step RA are configured in the selected UL carrier of the cell (or in the BWP of the selected UL carrier of the cell), and random access resources/configuration for only 2 step RA are configured in the selected UL carrier of the cell (or in the BWP of the selected UL carrier of the cell), the UE selects 2 step RA and performs 2 step RA using the SI request resources/configuration for 2 step RA. If SI request resources/configuration for 2 step RA are configured in the selected UL carrier of the cell (or in the BWP of the selected UL carrier of the cell) and random access resources/configurations for both 2 step RA and 4 step RA are configured in the selected UL carrier of the cell (or in the BWP of the selected UL carrier of the cell), and if the RSRP of the downlink pathloss reference is not below a configured threshold, the UE selects 2 step RA and performs 2 step RA using the SI request resources/configuration for 2 step RA. If SI request resources/configuration for 4 step RA are configured in the selected UL carrier of the cell (or in the BWP of the selected UL carrier of the cell) and random access resources/configuration for only 4 step RA are configured in the selected UL carrier of the cell (or in the BWP of the selected UL carrier of the cell), the UE selects 4 step RA and performs 4 step RA using the SI request resources/configuration for 4 step RA. If SI request resources/configuration for 4 step RA are configured in the selected UL carrier of the cell (or in the BWP of the selected UL carrier of the cell) and random access resources/configurations for both 2 step RA and 4 step RA are configured in the selected UL carrier of the cell (or in the BWP of the selected UL carrier of the cell) and if the RSRP of the downlink pathloss reference is below a configured threshold, the UE selects 4 step RA and performs 4 step RA using the SI request resources/configuration for 4 step RA.

The BWP of the cell can be the initial uplink BWP of the selected UL carrier. If the UE is neither a redcap UE nor an eRedcap UE, the BWP of the cell can be the initial uplink BWP of the selected UL carrier. If the UE is a (e) redcap UE, the BWP of the cell can be a redcap specific initial uplink BWP of the selected UL carrier. If the UE is a (e) redcap UE, the BWP of the cell can be the initial uplink BWP (if a redcap specific initial uplink BWP is not configured) of the selected UL carrier. The random access resources/configuration for 4 step RA can be the random access resources/configuration for 4 step RA not associated with any feature (note that there can be several random access resources/configurations where each can be associated with a feature/feature combination. The feature can be SDT, redcap, Msg3 repetition, Msg1 repetitions etc.).

The random access resources/configuration for 4 step RA can be the random access resources/configuration for 4 step RA associated with the SI request. The random access resources/configuration for 4 step RA can be the random access resources/configuration for 4 step RA associated with Msg3 repetition, if criteria to apply Msg3 repetition is met for the random access procedure initiated for SI request. The random access resources/configuration for 4 step RA can be the random access resources/configuration for 4 step RA associated with a specific Msg1 repetition number, if criteria to apply that Msg1 repetition number is met for the random access procedure initiated for SI request.

The random access resources/configuration for 2 step RA can be the random access resources/configuration for 2 step RA associated with the SI request. The random access resources/configuration for 2 step RA can be the random access resources/configuration for 2 step RA associated with Msg3 repetition, if criteria to apply Msg3 repetition is met for the random access procedure initiated for the SI request. The random access resources/configuration for 2 step RA can be the random access resources/configuration for 2 step RA associated with a specific Msg1 repetition number, if criteria to apply that Msg1 repetition number is met for random access procedure initiated for SI request.

At operation 825, if the selected RA type is 2 step RA, procedure 800 proceeds to operation 830. Otherwise, the procedure 800 proceeds to operation 845.

At operation 830, first the UE selects a random access preamble from random access preamble(s) configured in the SI request resources/configuration for 2 step RA in the selected UL carrier of the cell (or in the BWP of the selected UL carrier of the cell). Multiple random access preambles can be configured by the SI request resources/configuration for 2 step RA, wherein each preamble is associated with an SSB/CSI RS amongst the SSB/CSI RSs mapped to one PRACH occasion. The UE selects a random access preamble corresponding to the selected SSB/CSI RS from the random access preamble(s) configured in the SI request resources/configuration for 2 step RA in the selected UL carrier of the cell (or in the BWP of the selected UL carrier of the cell). The UE may select an SSB/CSI RS based on an SS-RSRP/CSI-RSRP of SSBs/CSI RSs transmitted by the cell. In some embodiments, ra-PreambleStartIndex may be signaled. In these embodiments, if N SSBs are associated with a RACH occasion, where N>=1, for the i-th SSB (i=0, . . . , N−1) the preamble with preamble index=ra-PreambleStartIndex+i is used for the SI request. For N<1, the preamble with preamble index=ra-PreambleStartIndex is used for the SI request. In some embodiments, an RA preamble index can be signaled for each transmitted SSB in the cell, and the UE selects the RA preamble index corresponding to the selected SSB.

Second, at operation 830, the UE selects (e.g., randomly) a random access occasion (or PRACH occasion) from random access occasions (PRACH occasions) of 2 step RA configured by the random access resources/configuration of 2 step RA in the selected UL carrier of the cell (or in the BWP of the selected UL carrier of the cell). The random access occasion (or PRACH occasion) may be selected corresponding to an SSB/CSI RS. They UE may select an SSB/CSIRS based on SS-RSRP/CSI-RSRP of SSBs/CSI RSs transmitted by the cell. If a RACH occasion mask index is received in the SI request resources/configuration for 2 step RA in the selected UL carrier of the cell (or in the BWP of the selected UL carrier of the cell), the UE selects a random access occasion (or PRACH occasion) from random access occasions (PRACH occasions) associated with the selected SSB which are allowed based on the RACH occasion mask index.

In some embodiments, a set of PUSCH occasions can be configured by the SI request resources/configuration for 2 step RA in the selected UL carrier of the cell (or in the BWP of the selected UL carrier of the cell). These sets of PUSCH occasions are defined with respect to each PRACH slot (i.e., each slot including a PRACH occasion). The UE selects a PUSCH occasion corresponding to the selected SSB from the PUSCH occasions corresponding to the PRACH slot of the selected PRACH occasion. The PUSCH resource index can be signaled for each transmitted SSB in the SI request resources/configuration for 2 step RA. The SSBs (in ascending order of SSB index) can be sequentially mapped to the PUSCH resources indexes. For example, if SSB1 and SSB5 are transmitted in the cell, a PUSCH resource with index 1 (or 0) is assigned to SSB1 and a PUSCH resource with index 2 (or 1) is assigned to SSB 5. The PUSCH resource index indicates a valid PUSCH occasion and the associated DMRS resources corresponding to a PRACH slot. The PUSCH resource indexes are sequentially numbered and are mapped to valid PUSCH occasions corresponding to a PRACH slot which are ordered, first, in increasing order of frequency resource indexes for frequency multiplexed PUSCH occasions; second, in increasing order of DMRS resource indexes within a PUSCH occasion, where a DMRS_{id} resource index is determined first in an ascending order of a DMRS port index and then in an ascending order of a DMRS sequence index; third in increasing order of time resource indexes for time multiplexed PUSCH occasions within a PUSCH slot; and fourth, in increasing order of indexes for PUSCH slots. For the case of a contention free 2-step random access type, if this field is absent, the UE shall use the value 0.

At operation 835, the UE transmits the selected RACH preamble in the selected PRACH occasion and a MsgA MAC PDU in the selected PUSCH occasion, wherein the MsgA MAC PDU includes the SI request. The SI request indicates or include information indicating one or more requested SI messages/SIBs. In some embodiments, the SIB can be any SIB other than SIB1. In some embodiments, the SIB can be any SIB including SIB1.

At operation 840, the UE receives a MsgB including an SI request ack after transmitting the selected RACH preamble in the selected PRACH occasion and a MsgA MAC PDU in the selected PUSCH occasion. The MsgB is scheduled by a PDCCH addressed to a MsgB-RNTI. The UE monitors the PDCCH addressed to the MsgB-RNTI in a MsgB window after transmitting the selected RACH preamble in the selected PRACH occasion and a MsgA MAC PDU in the selected PUSCH occasion. After receiving the MsgB including SI request ack, UE receives requested SIB(s)/SI message(s) at operation 860. If the UE receives a MsgB including an UL grant and not an SI request ack after transmitting the selected RACH preamble in the selected PRACH occasion and a MsgA MAC PDU in the selected PUSCH occasion, the UE transmits a Msg3 (i.e., a MsgA MAC PDU is transmitted as a Msg3 MAC PDU) in the UL grant. The UE the receives a Msg4including an SI request ack after transmitting the Msg3. The Msg4 is scheduled by a PDCCH addressed to a TC-RNTI. The UE monitors for a PDCCH addressed to the TC-RNTI after transmitting the Msg3. After receiving the Msg4 including the SI request ack, the UE receives the requested SIB(s)/SI message(s) at operation 860.

At operations 845-860, the UE performs a MSG1 based SI request procedure according to existing procedures. That is to say, at operation 845, the UE selects a RACH preamble/PRACH occasion from the selected UL carrier's SI request resources/SI request resource configuration for 4 step RA. At operation 850, the UE transmits the selected RACH preamble in the selected PRACH occasion. At operation 855, the UE receives a RAR including an SI request ack. The RAR is scheduled by a PDCCH addressed to an RA-RNTI. Finally, at operation 860, the UE receives the requested SIB(s)/SI message(s).

Although FIG. 8 illustrates one example procedure 800 for acquiring an SI message, various changes may be made to FIG. 8. For example, while shown as a series of operations, various operations in FIG. 8 could overlap, occur in parallel, occur in a different order, occur any number of times, be omitted, or replaced by other operations.

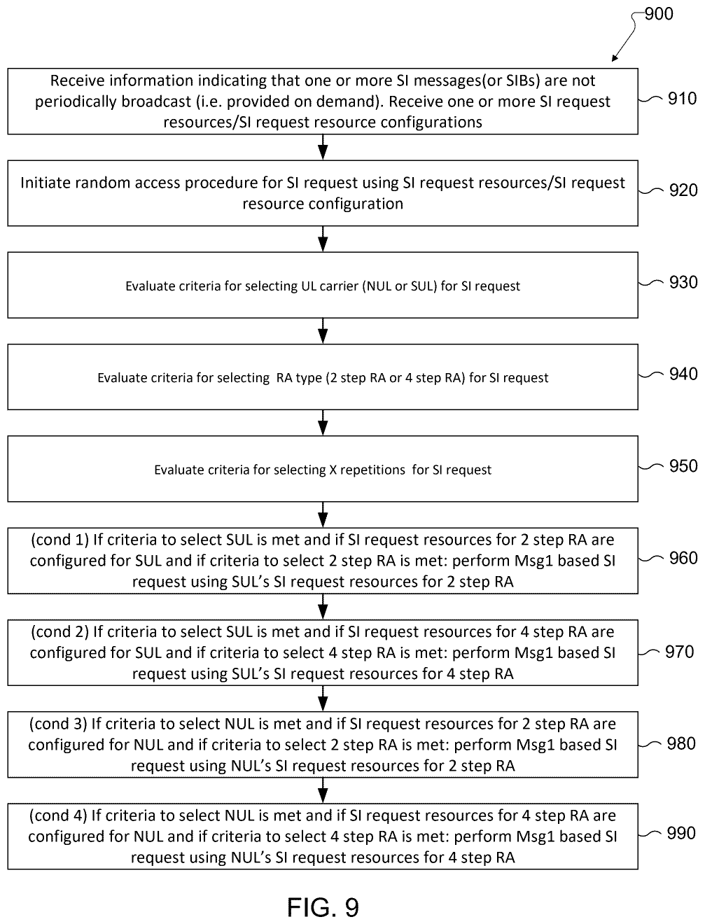

FIG. 9 illustrates another example procedure 900 for acquiring an SI message according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 9, procedure 900 beings at operation 910. At operation 910 a UE (such as UE 116 of FIG. 1) UE receives information indicating that one or more SI messages (or SIBs) of the currently camped cell are not periodically broadcast (e.g., information indicating that the SI messages are provided on demand). The indication that an SI message (or SIB) is not periodically broadcast (e.g., the information indicating the SI message is provided on demand) can be per SI message (or SIB) or can be common for all SI messages (SIBs) supported in the cell. UE also receives one or more SI request resources/SI request resource configurations. In some embodiments, the SI request resources/SI request resource configurations can be received for 4 step RA and/or 2 step RA. In some embodiments, the SI request resources/SI request resource configurations can be received for 4 step RA and/or 2 step RA separately for a SUL and an NUL. In some embodiments, each SI request resources/SI request resource configuration can be for a specific RA type and a specific UL carrier and a specific repetition number. The information can be received in a RRC message or system information. The information can be received from a gNB of the currently camped cell or from a neighboring cell.

In some embodiments, the SI request resources/SI request resource configuration for 2 step RA may indicate one or more preambles indexes, an RO mask index, one or more PUSCH resource index(s), and a PUSCH resource configuration. This information is common for an SI request for any SIB/SI message. In some embodiments, this information can be signaled separately for different group of SIBs/SI messages.

In some embodiments, ra-PreambleStartIndex can be signaled in the SI request resources/SI request resource configuration for 2 step RA. If N SSBs are associated with a RACH occasion, where N>=1, for the i-th SSB (i=0, . . . , N−1) the preamble with preamble index=ra-PreambleStartIndex+i is used for the SI request. For N<1, the preamble with preamble index=ra-PreambleStartIndex is used for the SI request.

At operation 920, if the UE is missing SI for operating in the currently camped cell and the SI is not broadcast in one or more SI messages (SIBs) (i.e., the SI message [or SIB] is provided on demand), the UE initiates a random access procedure to request one or more SI messages (SIBs).

At operation 930, the UE evaluates the criteria for selecting an UL carrier (NUL or SUL) of the cell for the SI request. In some embodiments, the criteria for selecting an UL carrier (NUL or SUL) of the cell for the SI request may be as follows:

If an SUL is supported in the cell and the RSRP (the RSRP may be derived from SSB/DL RS measurements of SSBs/DL RSs transmitted by the cell)>=rsrp-ThresholdSSB-SUL, the UE selects the NUL. If an SUL is supported in the camped cell and the RSRP (the RSRP may be derived from SSB/DL RS measurements of the camped cell)<rsrp-ThresholdSSB-SUL, the UE selects the SUL. If an SUL is not supported in the camped cell, the UE selects the NUL.

At operation 940, the UE evaluates the criteria for selecting an RA type (2 step RA or 4 step RA) for the SI request. In some embodiment the criteria for selecting an RA type (2 step RA or 4 step RA) for the SI request may be as follows:

If random access resources/configuration for only 2 step RA are configured in the selected UL carrier of the cell (or in the BWP of the selected UL carrier of the cell), the UE selects 2 step RA. If random access resources/configurations for both 2 step RA and 4 step RA are configured in the selected UL carrier of the cell (or in the BWP of the selected UL carrier of the cell), and if the RSRP of the downlink pathloss reference is not below a configured threshold, the UE selects 2 step RA. If random access resources/configuration for only 4 step RA are configured in the selected UL carrier of the cell (or in the BWP of the selected UL carrier of the cell), the UE selects 4 step RA. If random access resources/configurations for both 2 step RA and 4 step RA are configured in the selected UL carrier of the cell (or in the BWP of the selected UL carrier of the cell) and if the RSRP of the downlink pathloss reference is below a configured threshold, the UE selects 4 step RA.

At operation 940, the UE evaluates the criteria for selecting RA with X repetitions for the SI request. In some embodiment the criteria for selecting RA with X repetitions for the SI request may be as follows:

If si-RequestResourcesRepetitionNum8 is configured and the RSRP of the downlink pathloss reference is less than rsrp-ThresholdMsg1-RepetitionNum8, the criteria to apply Msg1 repetition for the SI request is considered met and the Msg1 repetition number applicable is 8. Otherwise, if si-RequestResourcesRepetitionNum4 is configured and the RSRP of the downlink pathloss reference is less than rsrp-ThresholdMsg1-RepetitionNum4, the criteria to apply Msg1 repetition for the SI request is considered met and the Msg1 repetition number applicable is 4. Otherwise, if si-RequestResourcesRepetitionNum2 is configured and the RSRP of the downlink pathloss reference is less than rsrp-ThresholdMsg1-RepetitionNum2, the criteria to apply Msg1 repetition for the SI request is considered met and the Msg1 repetition number applicable is 2.

At operation 960, if criteria to select a SUL is met and if SI request resources for 2 step RA are configured for the SUL of the cell (or in the BWP of the SUL carrier of the cell) and if criteria to select 2 step RA is met, the UE performs a MsgA based SI request using the SUL's SI request resources for 2 step RA similar as described regarding procedure 800 of FIG. 8 for the case (i.e., at operation 825) where the RA type selected is 2 step RA. If criteria to select SUL is met and if SI request resources for 2 step RA for a X Msg1/MsgA repetition number are configured for the SUL of the cell (or in the BWP of the SUL carrier of the cell) and if the criteria to select X Msg1 repetition number is met, the UE performs MsgA based SI request with X repetitions using the SUL's SI request resources for 2 step RA.

At operation 970, if criteria to select a SUL is met and if SI request resources for 4 step RA are configured for the SUL of the cell (or in the BWP of the SUL carrier of the cell) and if criteria to select 4 step RA is met, the UE performs a Msg1 based SI request using the SUL's SI request resources for 4 step RA.

At operation 980, if criteria to select a NUL is met and if SI request resources for 2 step RA are configured for the NUL of the cell (or in the BWP of the NUL carrier of the cell) and if criteria to select 2 step RA is met, the UE performs a MsgA based SI request using the NUL's SI request resources for 2 step RA similar as described regarding procedure 800 of FIG. 8 for the case (i.e., at operation 825) where the RA type selected is 2 step RA. If criteria to select NUL is met and if SI request resources for 2 step RA for a X Msg1/MsgA repetition number are configured for NUL of the cell (or in the BWP of the SUL carrier of the cell) and if criteria to select X Msg1 repetition number is met, the UE performs a MsgA based SI request with X repetitions using the NUL's SI request resources for 2 step RA.

At operation 990, if criteria to select a NUL is met and if SI request resources for 4 step RA are configured for the NUL of the cell (or in the BWP of the NUL carrier of the cell) and if criteria to select 4 step RA is met, the UE performs a Msg1 based SI request using the NUL's SI request resources for 4 step RA.

The BWP of the cell can be the initial uplink BWP of the selected UL carrier. If the UE is neither a redcap UE nor an eRedcap UE, the BWP of the cell can be the initial uplink BWP of the selected UL carrier. If the UE is a (e) redcap UE, the BWP of the cell can be a redcap specific initial uplink BWP of the selected UL carrier. If the UE is a (e) redcap UE, the BWP of the cell can be an initial uplink BWP (if a redcap specific initial uplink BWP is not configured) of the selected UL carrier. The random access resources/configuration for 4 step RA can be the random access resources/configuration for 4 step RA not associated with any feature (note that there can be several random access resources/configurations where each can be associated with a feature/feature combination. The feature can be SDT, redcap, Msg3 repetition, Msg1 repetitions etc.).

The random access resources/configuration for 4 step RA can be the random access resources/configuration for 4 step RA associated with the SI request. The random access resources/configuration for 4 step RA can be the random access resources/configuration for 4 step RA associated with Msg3 repetition, if criteria to apply Msg3 repetition is met for the random access procedure initiated for the SI request. The random access resources/configuration for 4 step RA can be the random access resources/configuration for 4 step RA associated with a specific Msg1 repetition number, if criteria to apply that Msg1 repetition number is met for the random access procedure initiated for the SI request.

The random access resources/configuration for 2 step RA can be the random access resources/configuration for 2 step RA associated with the SI request. The random access resources/configuration for the 2 step RA can be the random access resources/configuration for 2 step RA associated with Msg3 repetition, if criteria to apply Msg3 repetition is met for the random access procedure initiated for the SI request. The random access resources/configuration for 2 step RA can be the random access resources/configuration for 2 step RA associated with a specific Msg1 repetition number, if criteria to apply that Msg1 repetition number is met for the random access procedure initiated for the SI request.

Although FIG. 9 illustrates one example procedure 900 for acquiring an SI message, various changes may be made to FIG. 9. For example, while shown as a series of operations, various operations in FIG. 9 could overlap, occur in parallel, occur in a different order, occur any number of times, be omitted, or replaced by other operations.

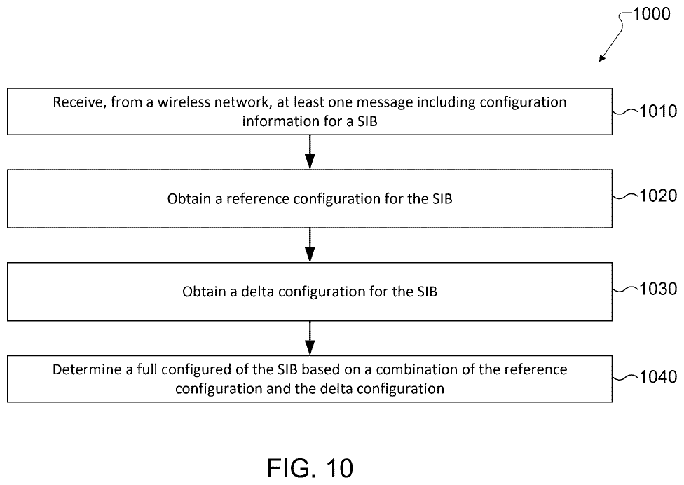

FIG. 10 illustrates an example method 1000 for receiving system information according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for receiving system information could be used without departing from the scope of this disclosure.

In the example of FIG. 10, method 1000 beings at step 1010. At step 1010, a UE (such as UE 116 of FIG. 1) receives, from a wireless network (such as wireless network 100 of FIG. 1, for example from BS 102), at least one message including configuration information for a SIB.

At step 1020, the UE obtains a reference configuration of the SIB. In some embodiments, the reference information may be preconfigured. In some embodiments, the configuration information included in the at least one message may include the reference configuration of the SIB.

At step 1030, the UE obtains a delta configuration of the SIB. In some embodiments, the configuration information included in the at least one message includes the delta configuration of the SIB.

At step 1040, the UE determines a full configuration of the SIB based on a combination of the reference configuration and the delta configuration. At least one of the reference configuration of the SIB and the delta configuration of the SIB are obtained based on the at least one message including the configuration information for the SIB.

In some embodiments, the UE may transmit, to the wireless network, a message including a request for at least one of the delta configuration of the SIB, the reference configuration of the SIB, and the full configuration of the SIB.

In some embodiments, where the configuration information included in the at least one message includes the reference configuration of the SIB, the at least one message is one of (i) a message signaled to the UE by NAS signaling, (ii) a message transmitted in response to registration of the UE on the wireless network, and (iii) a response to a UE request for the full configuration of the SIB or the reference configuration of the SIB.

In some embodiments, where the configuration information included in the at least one message includes the delta configuration of the SIB, the at least one message may be one of (i) a periodically broadcast message, and (ii) a response to a UE request for the delta configuration of the SIB.

In some embodiments, the reference configuration of the SIB may be associated with at least one of a valueTag and an area, and the UE may obtain the reference configuration of the SIB based on the association of at least one of the valueTag and the area with the reference configuration. In some embodiments, the configuration information included in the at least one message may include an indication of the at least one of the valueTag and the area.

In some embodiments, the UE may discard the obtained reference configuration of the SIB after a configured time.

Although FIG. 10 illustrates one example method 1000 for receiving system information, various changes may be made to FIG. 10. For example, while shown as a series of steps, various steps in FIG. 10 could overlap, occur in parallel, occur in a different order, occur any number of times, be omitted, or replaced by other steps.

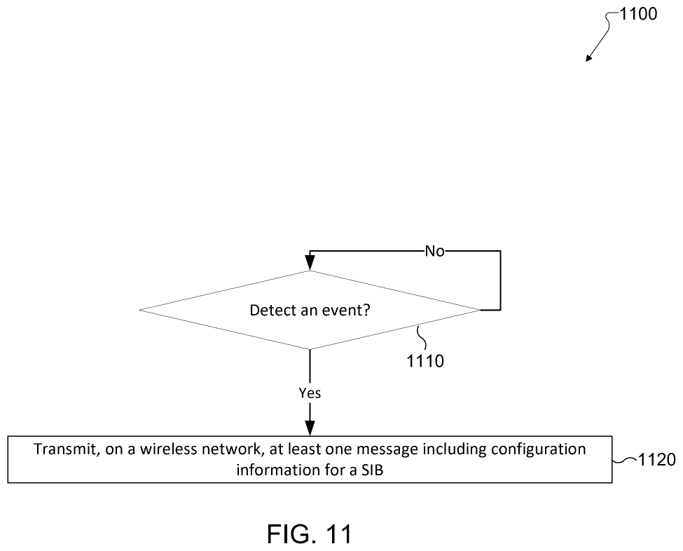

FIG. 11 illustrates an example method 1100 for transmitting system information according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for transmitting system information could be used without departing from the scope of this disclosure.

In the example of FIG. 11, method 1100 begins at step 1110. At step 1110, a BS (such as BS 102 of FIG. 1) waits for an event trigger to transmit configuration information for a SIB. If no event is detected, the BS continues to wait for an event trigger. If a trigger event is detected by the BS, the method proceeds to step 1120. For example, the trigger event may be a registration of a UE on the wireless network, a response to a UE request for the configuration information for the SIB, expiration of a timer that triggers transmission of a periodic message, etc.

At step 1120, the BS transmits, on a wireless network (such as wireless network 100 of FIG. 1), at least one message including configuration information for the SIB. The configuration information includes at least one of a reference configuration of the SIB and a delta configuration of the SIB.

In some embodiments, the at least one message may be a message signaled to a UE by NAS signaling, and the configuration information may include the reference configuration of the SIB.

In some embodiments, the at least one message may be a message transmitted in response to registration of a UE on the wireless network, and the configuration information may include the reference configuration of the SIB.

In some embodiments, the at least one message may be a response to a UE request for a full configuration or a reference configuration of the SIB, and the configuration information may include the reference configuration of the SIB.

In some embodiments, the at least one message may be a response to a UE request for a full configuration or a reference configuration of the SIB, and the configuration information may include the delta configuration of the SIB and the reference configuration of the SIB.

In some embodiments, the at least one message may be a response to a UE request for the delta configuration of the SIB, and the configuration information may include the delta configuration of the SIB.

In some embodiments, the at least one message may be a periodically broadcast message, and the configuration information may include the delta configuration of the SIB.

In some embodiments, the configuration information included in the at least one message may indicate at least one of a valueTag and an area associated with the reference configuration of the SIB.

Although FIG. 11 illustrates one example method 1100 for transmitting system information, various changes may be made to FIG. 11. For example, while shown as a series of steps, various steps in FIG. 11 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a wireless network, at least one message including configuration information for a system information block (SIB); and
a processor operably coupled to the transceiver, the processor configured to:
obtain a reference configuration of the SIB;
obtain a delta configuration of the SIB; and
determine a full configuration of the SIB based on a combination of the reference configuration and the delta configuration,
wherein at least one of the reference configuration of the SIB and the delta configuration of the SIB are obtained based on the at least one message including the configuration information for the SIB.

2. The UE of claim 1, wherein the processor is further configured to cause the transceiver to transmit, to the wireless network, a message including a request for at least one of the delta configuration of the SIB, the reference configuration of the SIB, and the full configuration of the SIB.

3. The UE of claim 1, wherein:
the reference configuration is preconfigured; or
configuration information included in the at least one message includes the reference configuration of the SIB; and
when the configuration information included in the at least one message includes the reference configuration of the SIB, the at least one message is one of:
a message signaled to the UE by non-access stratum (NAS) signaling;
a message transmitted in response to registration of the UE on the wireless network; and
a response to a UE request for the full configuration of the SIB or the reference configuration of the SIB.

4. The UE of claim 1, wherein:
the configuration information included in the at least one message includes the delta configuration of the SIB; and
the at least one message is one of:
a periodically broadcast message; and
a response to a UE request for the delta configuration of the SIB.

5. The UE of claim 1, wherein:
the reference configuration of the SIB is associated with at least one of a valueTag and an area; and
the processor is further configured to obtain the reference configuration of the SIB based on the association of at least one of the valueTag and the area with the reference configuration.

6. The UE of claim 5, wherein the configuration information included in the at least one message includes an indication of the at least one of the valueTag and the area.

7. The UE of claim 1, wherein the processor is further configured to discard the obtained reference configuration of the SIB after a configured time.

8. A base station (BS) comprising;
a processor; and
a transceiver operatively coupled with the processor, the transceiver configured to transmit, on a wireless network, at least one message including configuration information for a system information block (SIB), the configuration information including at least one of:
a reference configuration of the SIB; and
a delta configuration of the SIB.

9. The BS of claim 8, wherein:
the at least one message is one of:
a message signaled to a user equipment (UE) by non-access stratum (NAS) signaling;
a message transmitted in response to registration of the UE on the wireless network; and
a response to a UE request for a full configuration or reference configuration of the SIB; and
the configuration information includes the reference configuration of the SIB.

10. The BS of claim 9, wherein:
the at least one message is a response to a UE request for a full configuration or reference configuration of the SIB; and
the configuration information includes the delta configuration of the SIB and the reference configuration of the SIB.

11. The BS of claim 8, wherein:
the at least one message is a periodically broadcast message; and
the configuration information includes the delta configuration of the SIB.

12. The BS of claim 8, wherein:
the at least one message is a response to a user equipment (UE) request for the delta configuration of the SIB; and
the configuration information includes the delta configuration of the SIB.

13. The BS of claim 8, wherein configuration information included in the at least one message indicates at least one of a valueTag and an area associated with the reference configuration of the SIB.

14. A method of operating a user equipment (UE), the method comprising:
receiving, from a wireless network, at least one message including configuration information for a system information block (SIB);
obtaining a reference configuration of the SIB;
obtaining a delta configuration of the SIB; and
determining a full configuration of the SIB based on a combination of the reference configuration and the delta configuration,
wherein at least one of the reference configuration of the SIB and the delta configuration of the SIB are obtained based on the at least one message including the configuration information for the SIB.

15. The method of claim 14, further comprising transmitting, to the wireless network, a message including a request for at least one of the delta configuration of the SIB, the reference configuration of the SIB, and the full configuration of the SIB.

16. The method of claim 14, wherein:
the reference configuration is preconfigured; or
configuration information included in the at least one message includes the reference configuration of the SIB; and
when the configuration information included in the at least one message includes the reference configuration of the SIB, the at least one message is one of:
a message signaled to the UE by non-access stratum (NAS) signaling;
a message transmitted in response to registration of the UE on the wireless network; and
a response to a UE request for the full configuration of the SIB or the reference configuration of the SIB.

17. The method of claim 14, wherein:
the configuration information included in the at least one message includes the delta configuration of the SIB; and
the at least one message is one of:
a periodically broadcast message; and
a response to a UE request for the delta configuration of the SIB.

18. The method of claim 14, wherein:
the reference configuration of the SIB is associated with at least one of a valueTag and an area; and
the reference configuration of the SIB is obtained based on the association of at least one of the value Tag and the area with the reference configuration.

19. The method of claim 18, wherein the configuration information included in the at least one message includes an indication of the at least one of the value Tag and the area.

20. The method of claim 14, further comprising discarding the obtained reference configuration of the SIB after a configured time.
